(19) United States
(12) Patent Application Publication
(10) Pub. No.: US 2022/0034364 A1
(43) Pub. Date: Feb. 3, 2022

(54) METHOD FOR PRODUCING A SLIDING ELEMENT

(71) Applicant: Wieland-Werke AG, Ulm (DE)

(72) Inventors: Gerhard THUMM, Erbach (DE); Volker VOGGESER, Senden (DE)

(21) Appl. No.: 17/368,073

(22) Filed: Jul. 6, 2021

(30) Foreign Application Priority Data
Jul. 31, 2020 (DE) 102020004652.5

(51) Int. Cl. F16C 33/14; F16C 33/10; F16C 33/12

(52) U.S. Cl. CPC F16C 33/14; F16C 2220/44; F16C 33/125; F16C 33/1095

(57) ABSTRACT

A method for producing a sliding element, providing a first band-shaped or strip-shaped metallic material of a thickness, wherein the first material has apertures which extend over the entire thickness of the first material, providing a second band-shaped or strip-shaped metallic material of a thickness, areally connecting the first band-shaped or strip-shaped material to the second band-shaped or strip-shaped material by laser roll cladding such that a band-shaped or strip-shaped composite material is formed, which has a longitudinal direction X and a transverse direction, and has a thickness oriented perpendicularly with respect to the longitudinal and transverse directions. The method further includes bending the composite material about an axis oriented parallel to the transverse direction of the composite material, such that a sliding element is formed which has cutouts on its running surface that are formed at least partially from the apertures of the first material.

### CROSS-REFERENCE TO RELATED APPLICATION

This claims priority from German Application No. 10 2020 004 652.5, filed Jul. 31, 2020, the disclosure of which is hereby incorporated by reference in its entirety.

### TECHNICAL FIELD

The invention relates to a method for producing a sliding element having lubricating pockets.

### BACKGROUND AND SUMMARY

Sliding elements having lubricating pockets on the running surface are used in applications with particularly high loads on the bearing surfaces. The lubricating pockets may be formed as recesses in the running surface or as apertures which extend over the entire thickness of the sliding element. Perforated bushings are an example of such sliding elements.

Certain copper alloys have excellent sliding properties and are therefore suitable as a material for the running surface of sliding bearings. On account of the high metal price of copper, monometallic sliding bearings composed of such materials are expensive. Therefore, use is often made of composite materials in which a thin overlay composed of a copper material is applied to a steel back. The steel back has a significantly greater thickness than this overlay. In operation, the steel back absorbs the radial forces and ensures the mechanical stability of the bearing. The overlay composed of the copper material on the running surface of the sliding bearing imparts outstanding sliding properties to the bearing. For the production of such a composite material, various methods are known, for example melting the copper material onto the steel back or cladding. The running surface of a sliding bearing composed of such a composite material may have lubricating pockets. Document DE 10 2008 003 730 A1 describes such a two-layer sliding element, in the case of which the first layer has continuous apertures. These apertures serve as lubricant reservoir.

Document U.S. Pat. No. 6,095,690 A proposes introducing lubricating pockets into a metallic composite material by means of one-sided embossing of the bimetallic band material. The same method is known from document GB 1 454 385 A. The material that is deformed during the embossing operation remains in the sliding element and cannot be recovered.

As an alternative, lubricating pockets can be produced by punching apertures into the composite material. However, the resultant punching offcuts are not of one type and can therefore be recycled only with considerable effort. A sliding bearing bushing which can be produced by means of such a method is disclosed in document DE 203 00 854 U1.

The invention is based on the object of specifying an economical method for producing an inexpensive sliding element having lubricating pockets.

The invention is defined by the features of claim 1. The further dependent claims relate to advantageous embodiments and developments of the invention.

The invention encompasses a method for producing a sliding element, wherein the method comprises the following steps of:
a) providing a first band-shaped or strip-shaped metallic material of thickness D1, wherein the first material has apertures which extend over the entire thickness D1 of the first material,
b) providing a second band-shaped or strip-shaped metallic material of thickness D2,
c) areally connecting the first band-shaped or strip-shaped material to the second band-shaped or strip-shaped material by laser roll cladding, such that a band-shaped or strip-shaped composite material is formed, which has a longitudinal direction X and a transverse direction Y which is oriented transversely with respect to the longitudinal direction X, and has the thickness D perpendicularly with respect to the longitudinal and transverse directions,
d) bending the composite material about an axis A, which is oriented parallel to the transverse direction Y of the composite material, such that a bent sliding element is formed, and the sliding element has cutouts on its running surface that are formed at least partially from the apertures of the first material.

The invention relates to a method for producing a sliding element having cutouts that may serve as lubricating pockets. In the method, a first band-shaped or strip-shaped metallic material is provided. The first material has a width B1 and a thickness D1. The thickness D1 is smaller than the width B1. As a strip-shaped material, said first material has a defined length. As a band-shaped material, said first material has an undefined length. The first material may be composed of a bearing material, in particular of a copper or aluminum alloy. The first material has a plurality of apertures which extend, like in the case of a perforated plate, over the entire thickness of the material. The first material is thus perforated.

Furthermore, a second band-shaped or strip-shaped metallic material is provided. The second material has a width B2 and a thickness D2. The thickness D2 is smaller than the width B2. As a strip-shaped material, said second material has a defined length. As a band-shaped material, said second material has an undefined length. The second material usually differs from the first material. A favorable material having high strength is advantageously selected for the second material. The second material can comprise in particular steel. The thickness D2 of the second metallic material is preferably greater than the thickness D1 of the first metallic material. The thickness D2 of the second material is particularly preferably at least three times the thickness D1 of the first material. It is thus possible to produce thick-walled sliding elements in an economical manner.

The first and the second material are connected to one another by laser roll cladding such that a band-shaped or strip-shaped composite material is formed. In laser roll cladding, two band-shaped or strip-shaped materials are brought together in an areal manner upstream of a roll stand and heated by means of laser radiation directly before entry into the rolling tool. On account of the heating, rapid intermetallic diffusion between the two materials takes place during the rolling operation, such that a solid metallic composite is produced even in the case of a low degree of deformation during the rolling operation. The laser roll cladding can be carried out on the basis of the teaching of document DE 44 29 913 C1.

The composite material thus formed has a longitudinal direction X and a transverse direction Y. A strip-shaped composite material having a defined length is produced from a strip-shaped first material and a strip-shaped second material. As an alternative, a band-shaped composite material is produced from a band-shaped first material and a band-shaped second material. The band-shaped composite material is subsequently cut to a finite length. On account of the low degree of deformation required during the laser roll cladding, the thickness D of the composite material is only slightly smaller than the sum of the thicknesses D1 and D2 of the two starting materials.

The sliding element is produced from the band-shaped or strip-shaped composite material by bending the composite material about an axis which is oriented parallel to the transverse direction of the material composite. The sliding element has an outer and an inner surface, of which one serves as running surface. The apertures of the first material form cutouts on one side of the composite material. The running surface of the sliding bearing therefore has cutouts which are formed at least partially from the apertures of the first material. These cutouts may serve as lubricating pockets. The particular advantage of the method is that, on account of the low degree of deformation during the laser roll cladding, there is barely any reduction in the respective thickness of the starting materials, and that the material of the second material is not pushed into the apertures of the first material, or is pushed therein only to an insignificant extent, during the cladding process. The apertures of the first material thus remain substantially unchanged in terms of their original shape and depth. This is not the case in cladding methods that require a greater degree of deformation. Furthermore, the depth of the cutouts formed from the apertures can be adjusted by the thickness D1 of the first material. Since the thickness of the starting materials can be selected in a wide range in the case of laser roll cladding, it is possible to produce a composite material having lubricating pockets with virtually any desired depth.

A further advantage of this method is that the apertures are introduced prior to the cladding operation, and thus into a monometallic material. The resultant material waste is thus of one type and can be readily recycled in the scrap cycle.

In a particular embodiment of the method, the apertures of the first material may be closed by the second material at the boundary surface of the two materials. In this case, after the cladding process, said apertures form cutouts which are open on one side and which are in the form of pockets whose depth extends only over the thickness of the first material.

In particular, the composite material may be bent to form a bushing, that is to say a sleeve-shaped body. In this case, the bending is effected such that the two ends of the composite material are brought together, wherein a butt joint is formed which runs parallel to the bending axis. As an alternative, the band-shaped or strip-shaped composite material may be bent to form a half-shell, which encloses an angle of approximately 180°.

Preferably, the bending is effected such that the first metallic material is located on that surface of the sliding element which faces toward the bending axis A, that is to say on the inner side of the bushing or of the half-shell. The inner side of the bushing then serves as running surface of the sliding element.

In a preferred refinement of the invention, the connecting of the first material to the second material in step c) may be effected in a full-area manner. For this, the width B1 of the first material has to be equal to the width B2 of the second material. The composite material thus formed then has a uniform width B. The installation space available for the sliding element is optimally utilized.

Advantageously, the cutouts may be filled with a lubricant, in particular a solid lubricant. The lubricant improves the sliding properties of the bearing. If the cutouts are configured in the form of pockets which are open on one side and the depth of which extends only over the thickness D1 of the first material, significantly less lubricant is required for the filling of the cutouts than in the case of sliding elements having apertures which extend over the entire thickness D of the composite material.

In the context of a particular embodiment of the method, the second material may have apertures which extend over the entire thickness of the second material. The cutouts of the second material lead to a significant saving of material and thus also to a reduction in the weight of the sliding element. The cutouts of the second material may be identical to the cutouts of the first material in terms of shape and size or may differ from the cutouts of the first material in terms of shape and/or size.

In the context of a specific refinement of this embodiment, the first material may be connected to the second material such that the apertures of the second material coincide with the apertures of the first material. The apertures of the first and of the second material lie, as it were, one on top of the other. In other words, they are aligned. The cutouts then extend over the entire thickness D of the composite material. The sliding elements produced from such a composite material have lubricating pockets with maximum volume.

In the context of a further specific refinement of this embodiment, the first material may be connected to the second material such that the apertures of the second material are arranged offset with respect to the apertures of the first material. The apertures of the first material are then closed by the second material at the boundary surface of the two materials. In this case, after the cladding process, the apertures of the first material form cutouts which are open on one side and which are in the form of pockets whose depth extends only over the thickness D1 of the first material. The sliding elements produced from such a composite material have maximum stability with a low weight. Particularly in this specific refinement of the embodiment of the invention, the cutouts of the second material may differ from the cutouts of the first material in terms of shape and/or size.

With regard to the position of the apertures of the first material relative to the apertures of the second material, every variant that lies between the two specific refinements described above may be taken into consideration. In particular, the two materials may be connected such that the apertures of the first material partially overlap with the apertures of the second material.

With regard to further technical features and advantages of the method according to the invention, reference is hereby explicitly made to the exemplary embodiments, to the figures and to the explanations in conjunction with the description of the figures and the exemplary embodiments.

### BRIEF DESCRIPTION OF THE DRAWINGS

Exemplary embodiments of the invention are explained in more detail with reference to the schematic drawings of the figures, in which:

FIG. 1 shows a first material with apertures;

FIG. 2 shows a second material;

FIG. 3 schematically shows the laser roll cladding process;

FIG. 4 shows a composite material;

FIG. 5 shows a bushing with lubricating pockets;

FIG. 6 shows a half-shell with lubricating pockets;

FIG. 7 shows a particular embodiment of the composite material; and

FIG. 8 shows a further particular embodiment of the composite material.

Mutually corresponding parts are provided with the same reference designations in all of the figures.

### DETAILED DESCRIPTION

FIG. 1 shows a first material 21 in the form of a band material of width B1 and of thickness D1. The band-shaped material extends over an undefined length in the X direction. The width B1 is measured in the Y direction. The thickness D1 is measured in a direction that is perpendicular to X and Y. The material has a multiplicity of apertures 3. The apertures 3 may have a round shape as in the illustrated case. Other shapes, such as for example oval, elongate, triangular or rectangular, are also possible.

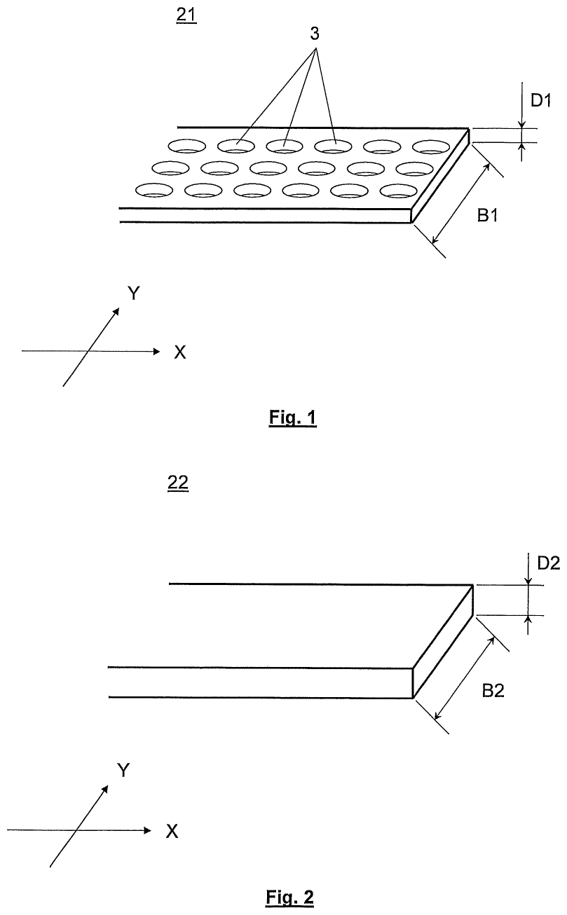

FIG. 2 shows a second material 22 in the form of a band material of width B2 and of thickness D2. The band-shaped material extends over an undefined length in the X direction. The width B2 is measured in the Y direction. The thickness D2 is measured in a direction that is perpendicular to X and Y. In the illustrated case, the second material 22 is embodied as a solid material and has planar surfaces. Neither apertures nor any other structural elements are present.

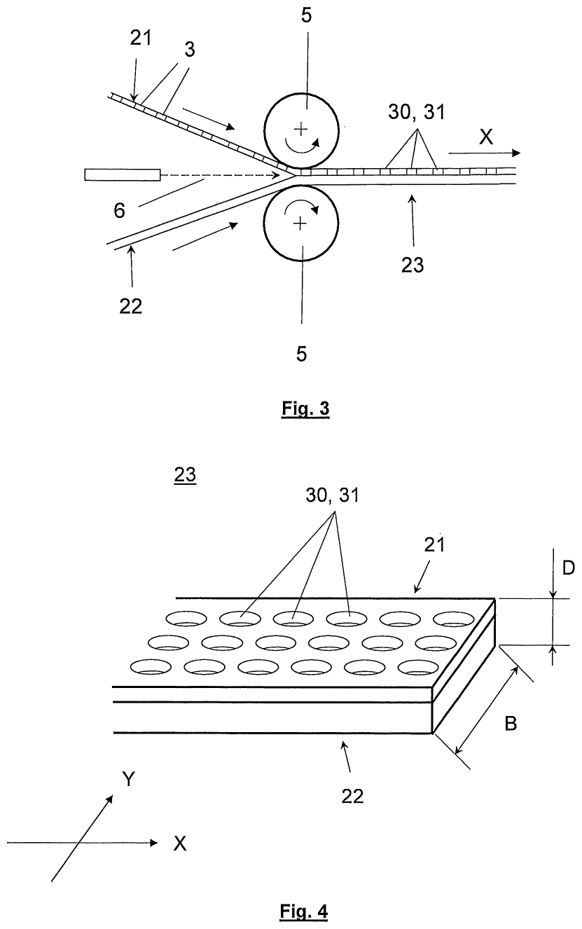

FIG. 3 schematically shows the laser roll cladding process. The working direction is from left to right. A first material 21, which has apertures 3 as in FIG. 1, is fed in the form of a virtually endless band to a rolling apparatus, of which only the two oppositely rotating rolling tools 5 are illustrated. A second material 22 as per FIG. 2 is also fed in the form of a virtually endless band to the rolling apparatus. The two materials 21, 22 are fed such that they come into areal contact with one another upstream of the rolling tools 5. Directly before the two materials 21, 22 enter the working region of the rolling tools 5, both materials 21, 22 are heated by a laser beam 6. On account of the high temperature of the materials 21, 22 that is achieved in this way, rapid intermetallic diffusion between the two materials 21, 22 takes place during the cladding process. Therefore, during the cladding process, only a very low degree of deformation is required in order to obtain a sufficiently strong materially bonded connection between the two materials 21, 22. The band-shaped composite material 23 thus produced has, on one of its surfaces, cutouts 30 in the form of pockets 31 which are open on one side and which correspond to the apertures 3 of the first material 21.

FIG. 4 shows the produced composite material 23. It is composed of the first material 21 and the second material 22. The width B of the composite material 23 is equal to the width B1 of the first material 21 and the width B2, which is identical thereto, of the second material 22. The thickness D of the composite material is approximately equal to the sum of the thickness D1 of the first material 21 and D2 of the second material 22. The composite material 23 has, on the surface that is formed by the first material 21, a multiplicity of cutouts 30 in the form of pockets 31 which are open on one side. Said cutouts are produced from the apertures 3 of the first material 21 in that the apertures 3 have been closed on one side by the second material 22.

FIG. 5 shows a sliding element 1 in the form of a rolled bushing 11. In order to produce the bushing 11, the composite material 23 as per FIG. 4 has been cut to a length that corresponds to the outer periphery of the bushing 11, and has been bent through virtually 360° about the axis A. A small butt joint 12 remains between the two ends of the composite material 23. The bushing 11 has an inner surface as running surface 14, which is formed from the first material 21, and an outer surface, which is formed from the second material 22. The running surface 14 thus has pockets 31 which can be filled with solid lubricant. As an alternative, it is also possible for the composite material 23 to be bent such that the outer surface is formed by the first material 21 and thus has lubricating pockets 31.

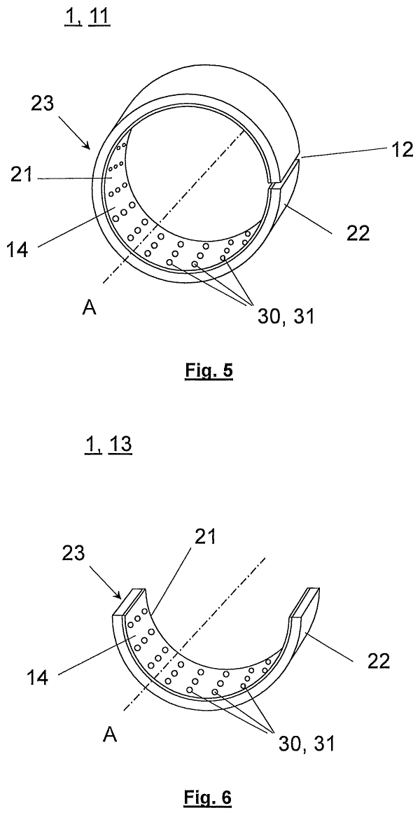

FIG. 6 shows a sliding element 1 in the form of a half-shell 13. In order to produce the half-shell 13, the composite material 23 as per FIG. 4 has been cut to a length that corresponds to the periphery of the half-shell 13, and has been bent through virtually 180° about the axis A. The half-shell 13 has an inner surface as running surface 14, which is formed from the first material 21, and an outer surface, which is formed from the second material 22. The running surface 14 thus has pockets 31 which can be filled with solid lubricant. As an alternative, it is also possible for the composite material 23 to be bent such that the outer surface is formed by the first material 21 and thus has lubricating pockets 31.

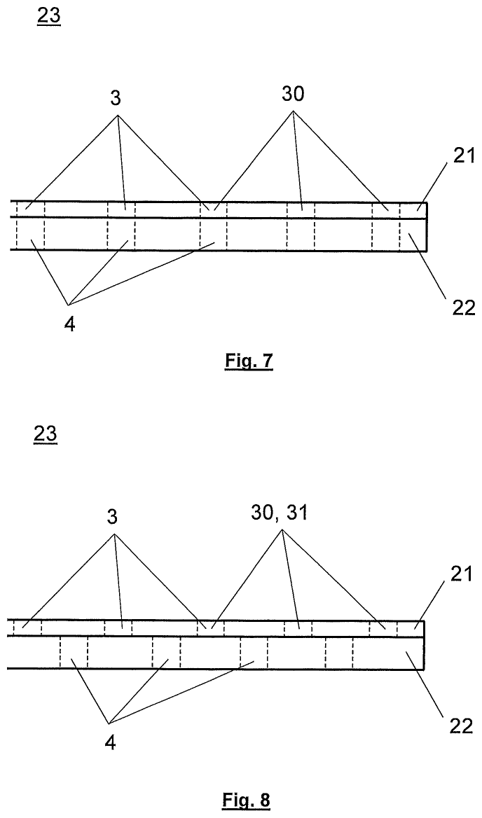

FIG. 7 schematically shows a side view of a particular embodiment of the composite material 23. It is not only the first material 21 that has apertures, but rather the second material 22 also has apertures 4 which have the same shape and size as the apertures 3 of the first material. The first material 21 has been connected to the second material 22 such that the apertures 4 of the second material 22 coincide with the apertures 3 of the first material. In this way, cutouts 30 have been formed which extend with a constant shape and size over the entire thickness of the composite material 23. As lubricant reservoir, these cutouts 30 have a maximum volume for the lubricant.

FIG. 8 schematically shows a side view of a further particular embodiment of the composite material 23. It is not only the first material 21 that has apertures, but rather the second material 22 also has apertures 4. The first material 21 has been connected to the second material 22 such that the apertures 4 of the second material 22 are arranged offset with respect to the apertures 3 of the first material 21. As in the case of the composite material 23 illustrated in FIG. 4, the apertures 3 of the first material 21 are closed by the second material 22 at the boundary surface of the two materials 21, 22, such that cutouts 30 in the form of pockets 31 which are open on one side are formed in that surface of the composite material 23 which is formed by the first material 21.

### LIST OF REFERENCE DESIGNATIONS

1 Sliding element
11 Bushing
12 Butt joint
13 Half-shell
14 Running surface
21 First material
22 Second material
23 Composite material
3 Aperture
30 Cutout
31 Pocket
4 Aperture
5 Rolling tool
6 Laser beam
A Axis
B Width
D Thickness
X Longitudinal direction
Y Transverse direction

1. A method for producing a sliding element, comprising the following steps of:
a) providing a first band-shaped or strip-shaped metallic material of a thickness, wherein the first material has apertures which extend over the entire thickness of the first material,
b) providing a second band-shaped or strip-shaped metallic material of a thickness,
c) areally connecting the first band-shaped or strip-shaped material to the second band-shaped or strip-shaped material by laser roll cladding, such that a band-shaped or strip-shaped composite material is formed, which has a longitudinal direction and a transverse direction, and has a thickness oriented perpendicularly with respect to the longitudinal and transverse directions,
d) bending the composite material about an axis, which is oriented parallel to the transverse direction of the composite material, such that a sliding element is formed which has cutouts on its running surface that are formed at least partially from the apertures of the first material.

2. The method according to claim 1, wherein the connecting of the first material to the second material in step c) is effected in a full-area manner.

3. The method according to claim 1, wherein the cutouts are filled with a lubricant.

4. The method according to claim 1, wherein the second material has apertures which extend over the entire thickness of the second material.

5. The method according to claim 4, wherein the first material is connected to the second material such that the apertures of the second material coincide with the apertures of the first material.

6. The method according to claim 4, wherein the first material is connected to the second material such that the apertures of the second material are arranged offset with respect to the apertures of the first material.

7. The method according to claim 1, wherein the cutouts are filled with a solid lubricant.
